(19) United States
(12) Patent Application Publication
(10) Pub. No.: US 2025/0056429 A1
(43) Pub. Date: Feb. 13, 2025

(54) LOW POWER ADAPTIVE POWER CONTROL

(71) Applicant: QUALCOMM Incorporated, San Diego, CA (US)

(72) Inventors: Xie YINGCHAO, Shanghai (CN); Jie ZENG, Shanghai (CN); Runyuan LIU, Shanghai (CN); Peng CHEN, Shanghai (CN)

(21) Appl. No.: 18/718,398

(22) PCT Filed: Feb. 24, 2022
(86) PCT No.: PCT/CN2022/077627

§ 371 Date: Jun. 10, 2024

(51) Int. Cl. H04W 52/38; H04W 52/24

(52) U.S. Cl. CPC H04W 52/383; H04W 52/241; H04W 52/246

(57) ABSTRACT

This disclosure describes techniques for transmitting, at a transmit power level, a plurality of audio packets over a Bluetooth connection to a peripheral device paired with the wireless device. The wireless device receives one or more NACK frames from the peripheral device, each NACK frame indicating a number of the transmitted audio packets that were not successfully decoded by the peripheral device. The wireless device obtains a percentage of the plurality of transmitted audio packets that were not successfully decoded by the peripheral device. and obtains signal strengths of one or more of the plurality of audio packets transmitted to the peripheral device. The wireless device selectively adjusts the transmit power level based on the percentage and the signal strengths.

### CROSS REFERENCE

The present Application is a 371 national stage filing of International PCT Application No. PCT/CN2022/077627 by YINGCHAO et al. entitled “LOW POWER ADAPTIVE POWER CONTROL,” filed Feb. 24, 2024, which is assigned to the assignee hereof, and which is expressly incorporated by reference in its entirety herein.

### TECHNICAL FIELD

This disclosure relates generally to wireless communications, and more specifically, to transmitting data to a Bluetooth-connected device over a Wi-Fi channel.

### DESCRIPTION OF THE RELATED TECHNOLOGY

A wireless personal area network (WPAN) is a short-range wireless network typically established by a user to interconnect various personal devices, sensors, and/or appliances located within a certain distance or area of the user. For example, WPANs based on communication protocols such as a Bluetooth® (BT) protocol, a Bluetooth® Low Energy protocol, or a Zigbee® protocol may provide wireless connectivity to peripheral devices within a specific distance (such as 5 meters, 10 meter, 20 meters, 100 meters, etc.) of the user.

Bluetooth is a short-range wireless communication protocol that supports a WPAN between a central device (such as a host device) and at least one peripheral device (such as a client device). Power consumption associated with Bluetooth communications may render Bluetooth impractical in certain applications.

To address the power consumption issue associated with Bluetooth, Bluetooth® Low Energy (BLE) was developed and adopted in various applications in which data transfers are relatively infrequent. Specifically, BLE exploits the infrequent transfer of data by using a low duty cycle operation, and placing one or both the central device and the peripheral device(s) into a sleep mode between data transmissions, thereby conserving power. Example applications that use BLE include battery-operated sensors and actuators in various medical, industrial, consumer, and fitness applications. BLE may also be used to connect devices such as BLE enabled smart phones, tablets, and laptops. While traditional Bluetooth and BLE offer certain advantages, there exists a need for further improvements in Bluetooth and BLE technology. For example, traditional Bluetooth and BLE have limited range, have limited data capacity throughput, and are susceptible to interference from other devices communicating in the same frequency band (such as Wi-Fi communications).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description presented later.

One innovative aspect of the subject matter described in this disclosure can be implemented as a method for wireless communication by a wireless device. In some implementations, the method includes transmitting, at a transmit power level, a plurality of audio packets over a Bluetooth connection to a peripheral device paired with the wireless device. The method includes receiving one or more NACK frames over the Bluetooth connection from the peripheral device, each NACK frame indicating a number of the transmitted audio packets that were not successfully decoded by the peripheral device. The method includes obtaining a percentage of the plurality of transmitted audio packets that were not successfully decoded by the peripheral device, and obtaining signal strengths of one or more audio packets of the plurality of audio packets transmitted to the peripheral device. The method includes selectively adjusting the transmit power level based on the percentage and the signal strengths.

In various implementations, the percentage may be indicative of a packet loss rate, a packet error rate (PER), or a level of interference on the Bluetooth connection. In some instances, the signal strengths may indicate received signal strength indicator (RSSI) values of at least some of the plurality of audio packets received at the peripheral device. In other instances, the signal strengths may indicate RSSI values of at least some of the NACK frames received from the peripheral device. In some aspects, the Bluetooth connection may be at least one of an asynchronous connection-less (ACL) link, a Logical Link Control and Adaptation Protocol (L2CAP) link, an Advanced Audio Distribution Profile (A2DP) link, a synchronous connection-oriented (SCO) link, or an isochronous (ISO) link.

In some implementations, selectively adjusting the transmit power level may include increasing the transmit power level based on the percentage being greater than a first value, or decreasing the transmit power level based on the percentage being less than a second value and the signal strengths being greater than a first level, the second value being less than the first value. In some instances, selectively adjusting the transmit power level may include maintaining the transmit power level at a current value based on the percentage being greater than the second value and less than the first value. In other instances, selectively adjusting the transmit power level may include maintaining the transmit power level at a current value based on the signal strengths being less than the first level and greater than a second level, the second level being less than the first level.

In other implementations, selectively adjusting the transmit power level may include increasing the transmit power level based on the signal strengths being less than a packet detect threshold, or decreasing the transmit power level based on the signal strengths being greater than a limit imposed by or associated with a regulatory body or government agency. In some instances, selectively adjusting the transmit power level may also be based on the percentage being less than the second value. In some other implementations, selectively adjusting the transmit power level may include increasing the transmit power level based on the wireless device and the peripheral device being separated from each other by more than a first distance, or decreasing the transmit power level based on the wireless device and the peripheral device being separated from each other by less than a second distance that is less than the first distance.

Another innovative aspect of the subject matter described in this disclosure can be implemented in a wireless device. In some implementations, the wireless device may include one or more wireless radios, one or more processors coupled to the one or more wireless radios, and a memory coupled to the one or more processors. In some implementations, the memory stores processor-readable code that, when executed by the one or more processors in conjunction with the one or more wireless radios, is configured to transmit, at a transmit power level, a plurality of audio packets over a Bluetooth connection to a peripheral device paired with the wireless device. Execution of the processor-readable code is configured to receive one or more NACK frames over the Bluetooth connection from the peripheral device, each NACK frame indicating a number of the transmitted audio packets that were not successfully decoded by the peripheral device. Execution of the processor-readable code is configured to obtain a percentage of the plurality of transmitted audio packets that were not successfully decoded by the peripheral device, and to obtain signal strengths of one or more audio packets of the plurality of audio packets transmitted to the peripheral device. Execution of the processor-readable code is configured to selectively adjust the transmit power level based on the percentage and the signal strengths.

In various implementations, the percentage may be indicative of a packet loss rate, a PER, or a level of interference on the Bluetooth connection. In some instances, the signal strengths may indicate RSSI values of at least some of the plurality of audio packets received at the peripheral device. In other instances, the signal strengths may indicate RSSI values of at least some of the NACK frames received from the peripheral device. In some aspects, the Bluetooth connection may be at least one of an ACL link, an L2CAP link, an A2DP link, an SCO link, or an ISO link.

In some implementations, selectively adjusting the transmit power level may include increasing the transmit power level based on the percentage being greater than a first value, or decreasing the transmit power level based on the percentage being less than a second value and the signal strengths being greater than a first level, the second value being less than the first value. In some instances, selectively adjusting the transmit power level may include maintaining the transmit power level at a current value based on the percentage being greater than the second value and less than the first value. In other instances, selectively adjusting the transmit power level may include maintaining the transmit power level at a current value based on the signal strengths being less than the first level and greater than a second level, the second level being less than the first level.

In other implementations, selectively adjusting the transmit power level may include increasing the transmit power level based on the signal strengths being less than a packet detect threshold, or decreasing the transmit power level based on the signal strengths being greater than a limit imposed by or associated with a regulatory body or government agency. In some instances, selectively adjusting the transmit power level may also be based on the percentage being less than the second value. In some other implementations, selectively adjusting the transmit power level may include increasing the transmit power level based on the wireless device and the peripheral device being separated from each other by more than a first distance, or decreasing the transmit power level based on the wireless device and the peripheral device being separated from each other by less than a second distance that is less than the first distance.

Another innovative aspect of the subject matter described in this disclosure can be implemented as a wireless device. In some implementations, the wireless device includes means for transmitting, at a transmit power level, a plurality of audio packets over a Bluetooth connection to a peripheral device paired with the wireless device. The wireless device includes means for receiving one or more NACK frames over the Bluetooth connection from the peripheral device, each NACK frame indicating a number of the transmitted audio packets that were not successfully decoded by the peripheral device. The wireless device includes means for obtaining a percentage of the plurality of transmitted audio packets that were not successfully decoded by the peripheral device, and means for obtaining signal strengths of one or more audio packets of the plurality of audio packets transmitted to the peripheral device. The wireless device includes means for selectively adjusting the transmit power level based on the percentage and the signal strengths.

In various implementations, the percentage may be indicative of a packet loss rate, a PER, or a level of interference on the Bluetooth connection. In some instances, the signal strengths may indicate RSSI values of at least some of the plurality of audio packets received at the peripheral device. In other instances, the signal strengths may indicate RSSI values of at least some of the NACK frames received from the peripheral device. In some aspects, the Bluetooth connection may be at least one of an ACL link, an L2CAP link, an A2DP link, an SCO link, or an ISO link.

In some implementations, selectively adjusting the transmit power level may include increasing the transmit power level based on the percentage being greater than a first value, or decreasing the transmit power level based on the percentage being less than a second value and the signal strengths being greater than a first level, the second value being less than the first value. In some instances, selectively adjusting the transmit power level may include maintaining the transmit power level at a current value based on the percentage being greater than the second value and less than the first value. In other instances, selectively adjusting the transmit power level may include maintaining the transmit power level at a current value based on the signal strengths being less than the first level and greater than a second level, the second level being less than the first level.

In other implementations, selectively adjusting the transmit power level may include increasing the transmit power level based on the signal strengths being less than a packet detect threshold, or decreasing the transmit power level based on the signal strengths being greater than a limit imposed by or associated with a regulatory body or government agency. In some instances, selectively adjusting the transmit power level may also be based on the percentage being less than the second value. In some other implementations, selectively adjusting the transmit power level may include increasing the transmit power level based on the wireless device and the peripheral device being separated from each other by more than a first distance, or decreasing the transmit power level based on the wireless device and the peripheral device being separated from each other by less than a second distance that is less than the first distance.

Another innovative aspect of the subject matter described in this disclosure can be implemented as a non-transitory computer-readable storage medium storing instructions, that, when executed by one or more processors of a wireless device, cause the wireless device to perform one or more operations. In some implementations, the one or more operations include transmitting, at a transmit power level, a plurality of audio packets over a Bluetooth connection to a peripheral device paired with the wireless device. The one or more operations include receiving one or more NACK frames over the Bluetooth connection from the peripheral device, each NACK frame indicating a number of the transmitted audio packets that were not successfully decoded by the peripheral device. The one or more operations include obtaining a percentage of the plurality of transmitted audio packets that were not successfully decoded by the peripheral device, and obtaining signal strengths of one or more audio packets of the plurality of audio packets transmitted to the peripheral device. The one or more operations include selectively adjusting the transmit power level based on the percentage and the signal strengths.

In various implementations, the percentage may be indicative of a packet loss rate, a PER, or a level of interference on the Bluetooth connection. In some instances, the signal strengths may indicate RSSI values of at least some of the plurality of audio packets received at the peripheral device. In other instances, the signal strengths may indicate RSSI values of at least some of the NACK frames received from the peripheral device. In some aspects, the Bluetooth connection may be at least one of an ACL link, an L2CAP link, an A2DP link, an SCO link, or an ISO link.

Details of one or more implementations of the subject matter described in this disclosure are set forth in the accompanying drawings and the description herein. Other features, aspects, and advantages will become apparent from the description, the drawings, and the claims.

### BRIEF DESCRIPTION OF THE DRAWINGS

FIG. 1 shows a pictorial diagram of an example Wireless Personal Area Network (WPAN), according to various aspects of the present disclosure.

FIG. 2 shows a block diagram of a wireless device, according to various aspects of the present disclosure.

FIG. 3 shows a block diagram of a Bluetooth protocol stack, according to various aspects of the present disclosure.

FIGS. 4A-4C depict a wireless device and a peripheral device separated by difference distances.

FIG. 5 depicts an example transmission of a data packet from a wireless device to a peripheral device, according to various aspects of the present disclosure.

FIG. 6 shows a block diagram of another example wireless device, according to various aspects of the present disclosure.

FIG. 7 shows a sequence diagram depicting an example wireless communication that supports selectively adjusting a transmit power level of audio packets transmitted to a peripheral device, according to various aspects of the present disclosure.

FIGS. 8-14 show flowcharts illustrating example operations for wireless communications that support selectively adjusting a transmit power level of audio packets transmitted to a peripheral device, according to various aspects of the present disclosure.

FIG. 15 shows a conceptual data flow diagram illustrating the data flow between different means/components in an example apparatus.

FIG. 16 shows a diagram illustrating an example of a hardware implementation for an apparatus employing a processing system.

Like reference numbers and designations in the various drawings indicate like elements.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Communications based on traditional Bluetooth and BLE suffer from several limitations that can limit user experiences and negatively affect user experiences. For example, the range of traditional Bluetooth and BLE is limited by a single hop radio frequency (RF) transmission. Additionally, traditional Bluetooth and BLE have limited data capacity, which can have several negative effects on user experience. For example, the limited data capacity of traditional Bluetooth and BLE can result in limited audio quality or a quality level unacceptable to the user.

To improve the quality and reliability of Bluetooth audio, the Bluetooth specification defines a Bluetooth Low Energy (LE) Audio protocol that allows a wireless device to transmit a Bluetooth audio stream to one or more peripheral devices over an Isochronous (ISO) link that incorporates features of both synchronous links and asynchronous links. For example, when transmitting an audio stream to one or more peripheral devices over an ISO link, the Bluetooth LE Audio protocol allows audio packets of the audio stream to be asynchronously transmitted to the peripheral devices, thereby avoiding synchronization issues between the wireless device and the peripheral devices. The Bluetooth LE Audio protocol also allows a limited number of retransmission attempts by the wireless device if the peripheral devices do not receive, or are unable to successfully decode, one or more of the audio packets transmitted by the wireless device.

Peripheral devices may support some, but not all, of the features associated with Bluetooth LE audio. For example, when a wireless device is paired with a peripheral device that does not support power control features, the wireless device typically transmits Bluetooth audio streams to the peripheral device at a fixed or configured power level associated with a certain distance between the wireless device and the peripheral device. Although suitable for some arrangements between the wireless device and the peripheral device, this fixed or configured power level may not be suitable as the distance between the wireless device and the peripheral device changes. For example, as the distance between the wireless device and the peripheral device increases, the fixed or configured power level becomes increasingly insufficient to ensure the proper delivery of Bluetooth audio packets to the peripheral device, and eventually results in an unacceptable level of packet loss and poor audio quality. Conversely, as the distance between the wireless device and the peripheral device decreases, the fixed or configured power level becomes increasingly excessive and results in unnecessary power consumption. Moreover, the fixed or configured power level may not be suitable as channel conditions between the wireless device and the peripheral device change.

Implementations of the subject matter described in this disclosure may be used to selectively adjust the transmit power level used by a wireless device for transmitting Bluetooth audio packets over a wireless medium to a peripheral device. In some implementations, the wireless device transmits a plurality of audio packets to a peripheral device using an initial transmit power level. The peripheral device receives at least some of the audio packets, and determines which of the transmitted audio packets are missing (e.g., transmitted audio packets that were not received or not successfully decoded by the peripheral device). The peripheral device transmits, to the wireless device, one or more NACKs that identify the missing audio packets. The wireless device may obtain, from the received NACKs, a percentage of the transmitted audio packets that were not received or successfully decoded by the peripheral device. The wireless device may also obtain indications of the signal strengths of the audio packets transmitted to the peripheral device. In response thereto, the wireless device may selectively adjust the transmit power level used for transmitting the audio packets based on the percentage and the signal strengths. The wireless device may subsequently transmit additional audio packets to the peripheral device using the adjusted transmit power level, rather than the initial transmit power level. In this way, aspects of the present disclosure may ensure that audio packets are transmitted from the wireless device to the peripheral device with sufficient energy to minimize packet loss and ensure a certain audio quality while also minimizing power consumption.

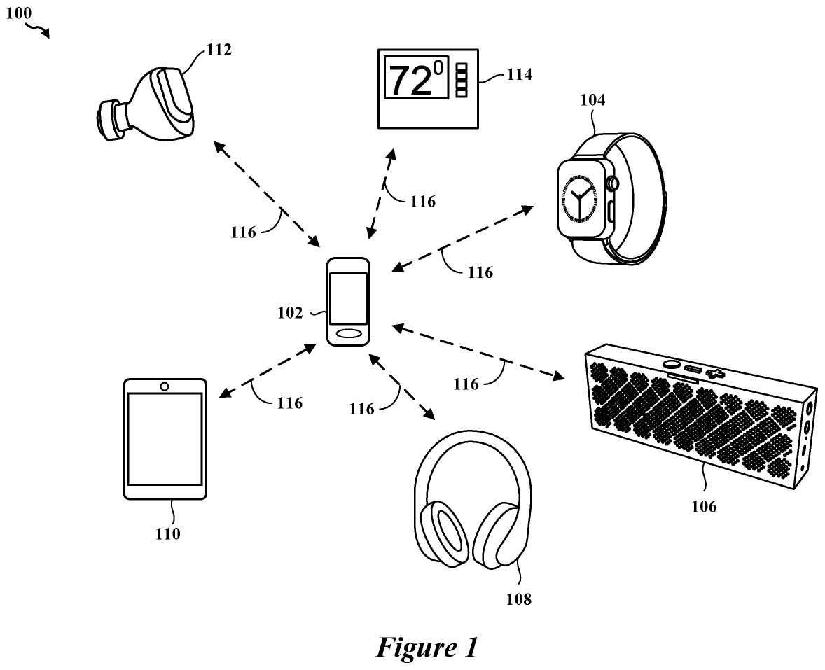

FIG. 1 shows a pictorial diagram of an example Wireless Personal Area Network (WPAN) 100, according to some implementations. Within the WPAN 100, a central device 102 may connect to and establish a BLE communication link 116 with one or more peripheral devices 104, 106, 108, 110, 112, 114 using a BLE protocol or a modified BLE protocol. The BLE protocol is part of the BT core specification and enables radio frequency communication operating within the globally accepted 2.4 GHz Industrial, Scientific & Medical (ISM) band.

The central device 102 may include suitable logic, circuitry, interfaces, processors, and/or code that may be used to communicate with one or more peripheral devices 104, 106, 108, 110, 112, or 114 using the BLE protocol or the modified BLE protocol as described herein. The central device 102 may operate as an initiator to request establishment of a Link Layer (LL) connection with an intended peripheral device 104, 106, 108, 110, 112, or 114. A Link Manager may be used to control operations between a BToIP application controller in the central device 102 and a BToIP application controller in each of the intended peripheral devices 104, 106, 108, 110, 112, and/or 114.

After a requested link layer connection is established, the central device 102 may become a host device, and the selected or intended peripheral device 104, 106, 108, 110, 112, or 114 may become paired with the central device 102 over the established link layer connection. As a host device, the central device 102 may be capable of supporting multiple link layer connections at a time with various peripheral devices 104, 106, 108, 110, 112, or 114 operating as client devices. Specifically, the central device 102 may manage various aspects of data packet communication in a link layer connection with one or more of the associated peripheral devices 104, 106, 108, 110, 112, or 114. For example, the central device 102 may determine an operation schedule in the link layer connection with one or more peripheral devices 104, 106, 108, 110, 112, or 114. The central device 102 may also initiate a link layer protocol data unit (PDU) exchange sequence over the link layer connection. Link layer connections may be configured to run periodic connection events in dedicated data channels. The exchange of link layer data PDU transmissions between the central device 102 and one or more of the peripheral devices 104, 106, 108, 110, 112, or 114 may take place within connection events.

In some implementations, the central device 102 may be configured to transmit the first link layer data PDU in each connection event to an intended peripheral device 104, 106, 108, 110, 112, or 114. In other implementations, the central device 102 may utilize a polling scheme to poll the intended peripheral device 104, 106, 108, 110, 112, or 114 for a link layer data PDU transmission during a connection event. The intended peripheral device 104, 106, 108, 110, 112, or 114 may transmit a link layer data PDU upon receipt of packet link layer data PDU from the central device 102. In some other implementations, a peripheral device 104, 106, 108, 110, 112, or 114 may transmit a link layer data PDU to the central device 102 without first receiving a link layer data PDU from the central device 102.

Examples of the central device 102 may include a cellular phone, a smart phone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player, a camera, a game console, a tablet, a smart device, a wearable device (such as a smart watch, wireless headphones, etc.), a vehicle, an electric meter, a gas pump, a toaster, a thermostat, a hearing aid, a blood glucose on-body unit, an Internet-of-Things (IoT) device, or any other similarly functioning device.

Examples of the one or more peripheral devices 104, 106, 108, 110, 112, or 114 may include a cellular phone, a smart phone, a SIP phone, a STA, a laptop, a PC, a desktop computer, a PDA, a satellite radio, a global positioning system, a multimedia device, a video device, a digital audio player, a camera, a game console, a tablet, a smart device, a wearable device (such as a smart watch, wireless headphones, etc.), a vehicle, an electric meter, a gas pump, a toaster, a thermostat, a hearing aid, a blood glucose on-body unit, an IoT device, or any other similarly functioning device. Although the central device 102 is illustrated in communication with six peripheral devices 104, 106, 108, 110, 112, or 114 in the WPAN 100, the central device 102 may communicate with more or fewer than six peripheral devices within the WPAN 100 without departing from the scope of the present disclosure.

A device implementing the BT protocol, such as the central device 102, may operate according to one radio mode, such as basic rate (BR)/enhanced data rate (EDR), and a device implementing the BLE protocol may operation according to a BLE radio mode. In some aspects, the central device 102 may be configured with dual radio modes, and therefore may be able to operate according to the BR/EDR mode or the BLE mode, for example, based on the type of short-rage wireless communication in which the device may engage.

For example, the central device 102 may operate according to the BR/EDR mode for continuous streaming of data, for broadcast networks, for mesh networks, and/or for some other applications in which a relatively higher data rate may be more suitable. However, the device may operate according to the BLE mode for short burst data transmissions, such as for some other applications in which power conservation may be desirable and/or a relatively lower data rate may be acceptable. In other aspects, the central device 102 may operate according to one or more other radio modes, including proprietary radio mode(s). Examples of other radio modes may include high speedradio modes, low energy radio modes, isochronous radio modes, etc.

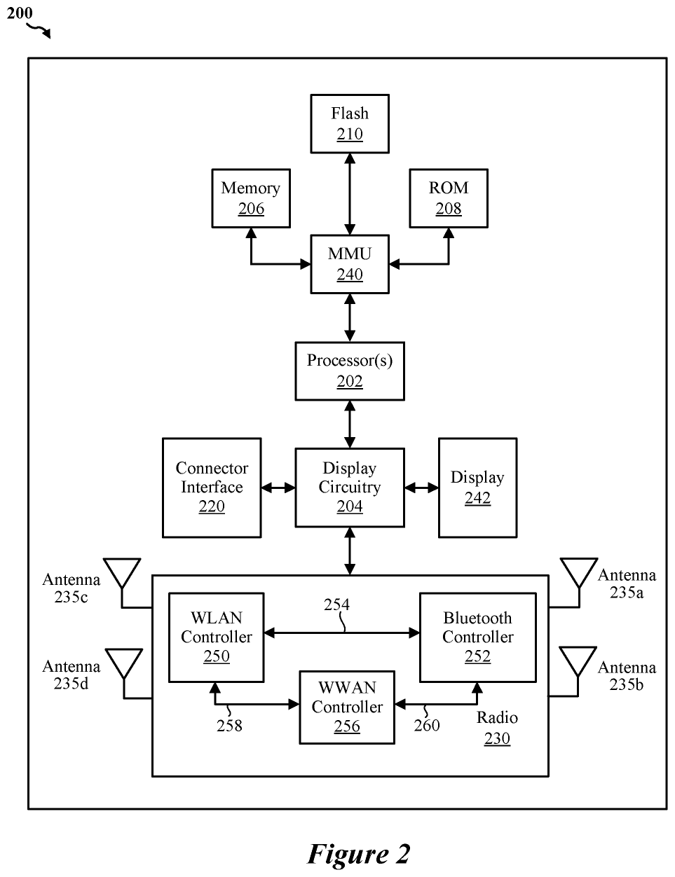

FIG. 2 shows a block diagram of a wireless device 200, according to some implementations. In some instances, the wireless device 200 may be an example of the central device 102 of FIG. 1. In other instances, the wireless device 200 may be an example of one or more of the peripheral devices 104, 106, 108, 110, 112, or 114 of FIG. 1. In some aspects, the wireless device 200 may be a Bluetooth-enabled device (such as a BLE device).

As shown, the wireless device 200 may include a processing element, such as processor(s) 202, which may execute program instructions for the wireless device 200. The wireless device 200 may also include a display 242 that can perform graphics processing and present information to a user. The processor(s) 202 may also be coupled to memory management unit (MMU) 240, which may be configured to receive addresses from the processor(s) 202 and translate the addresses to address locations in memory such as memory 206, ROM 208, or Flash memory 210) and/or to address locations in other circuits or devices, such as the display circuitry 204, radio 230, connector interface 220, and/or display 242. The MMU 240 may also be configured to perform memory protection and page table translation or set up. In some aspects, the MMU 240 may be included as a portion of the processor(s) 202.

The processor(s) 202 may be coupled to other circuits of the wireless device 200. For example, the wireless device 200 may include various types of memory, a connector interface 220 through which the wireless device 200 can communicate with the computer system, and wireless communication subsystems that can transmit data to, and receive data from, other devices based on one or more wireless communication standards or protocols. For example, in some aspects, the wireless communication subsystems may include (but are not limited to) a WLAN subsystem, a Bluetooth subsystem, or a cellular subsystem (such as an LTE or 5G NR subsystem). The wireless device 200 may include a plurality of antennas 235a, 235b, 235c, or 235d for performing wireless communication with, for example, wireless devices in a WPAN.

The wireless device 200 may be configured to implement part or all of the techniques described herein by executing program instructions stored on a memory medium (such as a non-transitory computer-readable memory medium) and/or through hardware or firmware operation. In other embodiments, the techniques described herein may be at least partially implemented by a programmable hardware element, such as an field programmable gate array (FPGA), and/or an application specific integrated circuit (ASIC).

In certain aspects, the radio 230 may include separate controllers configured to control communications for various respective radio access technology (RAT) protocols. For example, as shown in FIG. 2, radio 230 may include a WLAN controller 250 that manages WLAN communications, a Bluetooth controller 252 that manages Bluetooth and BLE communications, and a WWAN controller 256 that manages WWAN communications. In certain aspects, the wireless device 200 may store and execute a WLAN software driver for controlling WLAN operations performed by the WLAN controller 250, a Bluetooth software driver for controlling Bluetooth operations performed by the Bluetooth controller 252, and/or a WWAN software driver for controlling WWAN operations performed by the WWAN controller 256.

In certain implementations, a first coexistence interface 254 (such as a wired interface) may be used for sending information between the WLAN controller 250 and the Bluetooth controller 252. In certain other implementations, a second coexistence interface 258 may be used for sending information between the WLAN controller 250 and the WWAN controller 256. In certain other implementations, a third coexistence interface 260 may be used for sending information between the Bluetooth controller 252 and the WWAN controller 256.

In some aspects, one or more of the WLAN controller 250, the Bluetooth controller 252, and/or the WWAN controller 256 may be implemented as hardware, software, firmware or some combination thereof.

In certain configurations, the WLAN controller 250 may be configured to communicate with a second device in a WPAN using a WLAN link using all of the antennas 235a, 235b, 235c, and 235d. In certain other configurations, the Bluetooth controller 252 may be configured to communicate with at least one second device in a WPAN using one or more of the antennas 235a, 235b, 235c, and 235d. In certain other configurations, the WWAN controller 256 may be configured to communicate with a second device in a WPAN using all of the antennas 235a, 235b, 235c, and 235d. The WLAN controller 250, the Bluetooth controller 252, and/or the WWAN controller 256 may be configured to adjust wakeup time interval and shutdown time for the device.

A short-range wireless communications protocol, such as BT, BLE, and/or BR/EDR, may include and/or may use one or more other communications protocols, for example, for establishing and maintaining communications links. Referring also to FIG. 1, the wireless device 200 may establish a communications link 116 with one or more peripheral devices, such as a wireless headset 112, according to at least one communications protocol for short-range wireless communications.

The communications link 116 may include a communications link that adheres to a protocol included and/or for use with BT, BLE, BR/EDR, etc. In one aspect, the communications link 116 may include an asynchronous connection-less (ACL) link. When operating as an ASL link, the communications link 116 may allow the source device 102 to connect or “pair” with a peripheral device, such as the headset 112. The connection is asynchronous in that the two devices may not need to synchronize, time-wise, data communications between each other to permit communication of data packets via the communications link 116.

A Logical Link Control and Adaptation Protocol (L2CAP) may be used within a BT protocol stack (not shown in FIG. 2 for simplicity). An L2CAP connection may be established after an ACL link has been established. Reference to L2CAP in the present disclosure may be further applicable to enhanced L2CAP (EL2CAP), which may be an enhanced version of the L2CAP protocol that enables multiplexing of multiple logical data channels via a single radio connection.

In one aspect, the communications link 116 may include an Advanced Audio Distribution Profile (A2DP) link. An A2DP link provides a point-to-point link between a source device, such as the source device 102, and a sync device, such as the headset 112. With an A2DP link, data packets including audio may be transmitted over an ACL data channel, and other information, for example, for controlling the audio stream, may be transmitted over a separate control channel. The data packets may occur non-periodically.

In another aspect, the communications link 116 may support synchronous logical transport mechanisms between a source device (such as the source device 102) and a peripheral device (such as the headset 112). For example, the communications link 116 may include a synchronous connection-oriented (SCO) link that provides a symmetric point-to-point link between the source device and the peripheral device using time slots reserved for BT communications. In some aspects, an SCO link may not support retransmission of data packets, which may be unsatisfactory in audio streaming and/or voice use cases in which a dropped audio or voice packet may reduce the quality of the user experience.

In a further aspect, the communications link 116 may include an extended SCO (eSCO) link. An eSCO link may provide a symmetric or asymmetric point-to-point link between a source device and a peripheral device using time slots reserved for BT communications, and may also provide for a retransmission window following the reserved time slots. Because retransmissions may be facilitated using the retransmission window, an eSCO link may be suitable for audio streaming and/or voice use cases because a dropped audio or voice packet may be retransmitted, and therefore the probability of successfully receiving a data packet may be increased.

In one aspect, the communications link 116 may include an Isochronous (ISO) link. When operating as an ISO link, the communications link 116 may combine some features of both synchronous and asynchronous links. For example, a stream on an ISO link may begin with a start packet, and then data packets may be asynchronously transmitted. On an ISO link, the number of retransmission attempts by a transmitting device may be limited. Thus, if a receiving device is unable to decode a data packet within the limited number of retransmission attempts, then the data packet may be dropped and the receiving device may continue to receive the stream without data from the dropped data packet.

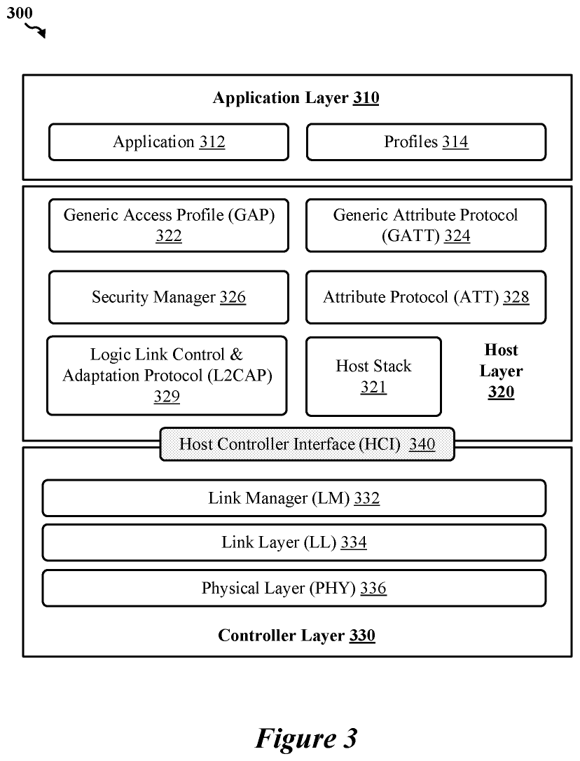

FIG. 3 shows a block diagram of a BT protocol stack 300 that may be implemented in a wireless device (such as the source device 102 or one or more of the peripheral devices 104, 106, 108, 110, or 112 of FIG. 1). For example, the BT protocol stack 300 may be implemented by one or more of processor(s) 202, memory 206, Flash memory 210, ROM 208, the radio 230, and/or the Bluetooth controller 252 illustrated in FIG. 2. The BT protocol stack 300 may be organized into three layers including Application layer 310, a Host layer 320, and a Controller layer 330.

The Application layer 310 may be a user application that interfaces with the other blocks and/or layers of the BT protocol stack 300. In some aspects, the Application layer 310 may include one or more applications 312 and one or more Bluetooth profiles 314 that allow the applications to use the Bluetooth and BLE communications. The Host layer 320 may include the upper layers of the BT protocol stack 300, and may communicate with a controller (such as the Bluetooth controller 252 of FIG. 2) in a wireless device using a Host Controller Interface (HCl) 340. In some aspects, the Host layer 320 may include a host stack 321 that can be used for application layer interface management to allow an application to access Bluetooth communications.

The Controller layer 330 may include the lower layers of the BT protocol stack 300. The Controller layer 330, which may be used for hardware interface management, link establishment, and link management, is shown to include a Link Manager (LM) 332, a Link Layer (LL) 334, and a physical (PHY) layer 336. The PHY layer 336 may include, for example, a radio and/or a baseband processor. In some aspects, the PHY layer 336 may define the mechanism for transmitting a bit stream over a physical link or channel that connects BT devices. The bit stream may be grouped into code words or symbols, and converted to a data packet that is transmitted over a wireless transmission medium. The PHY layer 336 may provide an electrical, mechanical, and/or procedural interface to the wireless transmission medium. The PHY layer 336 may be responsible for modulation and demodulation of data into radio frequency (RF) signals for transmission over the air. The PHY layer 336 may describe the physical characteristics of a wireless device's receiver/transmitter. The physical characteristics may include modulation characteristics, radio frequency tolerance, sensitivity level, etc.

The Link Layer 334 is responsible for low-level communication over the PHY layer 336. The Link Layer 334 334 manages the sequence and timing for transmitting and receiving data packets, and using a LL protocol, communicates with other devices regarding connection parameters and data flow control. The Link Layer 334 also provides gatekeeping functionality to limit exposure and data exchange with other devices. If filtering is configured, the Link Layer 334 maintains a list of allowed devices and will ignore all requests for data exchange from devices not on the list. The Link Layer 334 may also reduce power consumption. In some aspects, the Link Layer 334 may include a company's proprietary LL that may be used to discover peer devices, and establish a secure communication channel therewith. In certain aspects, the Link Layer 334 may be responsible for transporting data packets between devices in a WPAN. Each data packet may include an access address, which specifies the type of logical transport used to carry the data packet. Logical transports may exist between a master device and slave devices. Additionally, some logical transports may carry multiple logical links.

The Link Manager 332 may be responsible for establishing and configuring links and managing power-change requests, among other tasks. Each type of logical link, such as ACL links, A2DP links, SCO links, eSCO links, ISO links, etc., may be associated with a specific packet type. For example, an SCO link may provide reserved channel bandwidth for communication between a master device and a slave device, and support regular, periodic exchange of data packets with no retransmissions. An eSCO link may provide reserved channel bandwidth for communication between a source device and a peripheral device, and support regular, periodic exchange of data packets with retransmissions. An ACL link may exist between a source device and a peripheral device from the beginning of establishment of a connection between the source device and the peripheral device, and the data packets for ACL links may include encoding information in addition to a payload.

The Link Manager 332 may communicate with the Host layer 320 using the HCl 340. In some instances, the Link Manager 332 may translate HCl 340 commands into controller-level operations, such as baseband-level operations. The HCl 340 may act as a boundary between the lower layers (such as between the Controller layer 330, the Host layer 320, and the Application layer 310). The BT specification may define a standard HCl to support BT systems that are implemented across two separate processors. For example, a BT system on a computer may use the BT system's own processor to implement the lower layers of the BT protocol stack 300, such as the PHY layer 336, the Link Layer 334, and/or the Link Manager 332. In some aspects, the BT system may use a processor of a BT component to implement the other layers of the BT protocol stack 300 such as, for example, the Host layer 320 and the Application layer 310.

The Host layer 320 is shown to include a Generic Access Profile (GAP) 322, a Generic attribute Protocol (GATT) 324, a Security Manager (SM) 326, Attribute Protocol (ATT) 328, and a L2CAP layer 329. The GAP 322 may provide an interface for the application 312 to initiate, establish, and manage connections with other BT or BLE devices. The GATT 324 may provide a service framework using the attribute protocol for discovering services, and for reading and writing characteristic values on a peer device. The GATT 324 may interface with the application 312, for example, through a profile which may define a collection of attributes and any permission needed for the attributes to be used in BT or BLE communications.

The Security Manager 326 may be responsible for device pairing and key distribution. A security manager protocol implemented by the Security Manager 326 may define how communications with the Security Manager of a counterpart BLE device are performed. The Security Manager 326 provides additional cryptographic functions that may be used by other components of the BT protocol stack 300. The architecture of the Security Manager 326 used in Bluetooth communications is designed to minimize recourse requirements for peripheral devices by shifting work to an assumingly more powerful central device. BLE uses a pairing mechanism for key distribution. The Security Manager 326 provides a mechanism to not only encrypt the data but also to provide data authentication.

The ATT 328 includes a client/server protocol based on attributes associated with a BLE device configured for a particular purpose. Examples may include monitoring heart rate, temperature, broadcasting advertisements, etc. The attributes may be discovered, read, and written by peer devices. The set of operations which are executed over ATT 328 may include, but are not limited to, error handling, server configuration, find information, read operations, write operations, queued writes, etc. The ATT 328 may form the basis of data exchange between BT and BLE devices.

The L2CAP layer 329 may be implemented above the HCl 340, and may communicate with the controller layer 330 through the HCl 340. The L2CAP layer 329 may be primarily responsible for establishing connections across one or more existing logical links and for requesting additional links if none exist. The L2CAP layer 329 may also implement multiplexing between different higher-layer protocols, for example, to allow different applications to use a single link, such as a logical link, including an ACL link. In some implementations, the L2CAP layer 329 may encapsulate multiple protocols from the upper layers into a data packet format (and vice versa). The L2CAP layer 329 may also break packets with a large data payload from the upper layers into multiple packets with the data payload segmented into smaller size data payloads that fit into a maximum payload size (for example, twenty-seven bytes) on the transmit side.

In some standards and protocols, such as BLE and/or BR/EDR, the source device 102 may detect errors in a packet and/or a dropped/missed/not received packet through the use of cyclic redundancy check (CRC) validation and through the use of message integrity code (MIC) validation. MIC validation may be used when a packet is encrypted. For example, failure of CRC validation may indicate one or more errors in a received packet and failure of MIC validation may indicate that another packet has not been received (although failure of CRC validation may also indicate another packet has not been received and/or failure of MIC validation may also indicate one or more errors in a received packet).

CRC validation and MIC validation may be based on generating CRC values and MICs, respectively, based on received packets and respectively comparing those generated CRC values and MICs to CRC and MICs included in received packets. Specifically, a receiving device, such as the headset 112, that receives a packet may first generate a CRC value or a CRC checksum based on the received packet, such as based on a payload and, if applicable, a MIC included in the received packet. The receiving device may compare the generated CRC value with a CRC value included in the received packet. If the generated CRC value matches the CRC value included in the received packet, then the received packet may be validated for CRC. The CRC-validated received packet may then be decrypted. However, if the generated CRC value does not match the CRC value included in the received packet, then the receiving device may determine that the received packet fails CRC validation. If the receiving device determines the received packet fails CRC validation, then the received packet may include errors and/or may be corrupted. In one configuration, the receiving device may discard the received packet that fails CRC validation; however, in another configuration, the receiving device may attempt to recover the received packet, for example, using one or more error correction techniques.

If the received packet is encrypted and passes CRC validation, then the receiving device may decrypt the received packet to obtain a decrypted payload and a decrypted MIC. For MIC validation, the receiving device may generate a MIC based on the decrypted payload, and compare the generated MIC with the MIC obtained from the decrypted received packet. If the generated MIC matches the decrypted MIC, then the receiving device may determine that the received packet is successfully decrypted. When the received packet is successfully decrypted, the decoded and decrypted payload of the received packet may be provided to another layer of the receiving device, such as a coder-decoder (codec) of the receiving device that may cause the payload data of the received packet to be output by the receiving device, for example, as audio through speakers of the headset 112.

If the generated MIC does not match the decrypted MIC of the received packet, then the receiving device may determine that the received packet is unsuccessfully decrypted. When the received packet is unsuccessfully decrypted, then a different packet may have been missed or the received packet may be erroneous or otherwise corrupted. In one configuration, the receiving device may discard the received packet that fails MIC validation; however, in another configuration, the receiving device may attempt to recover the received packet.

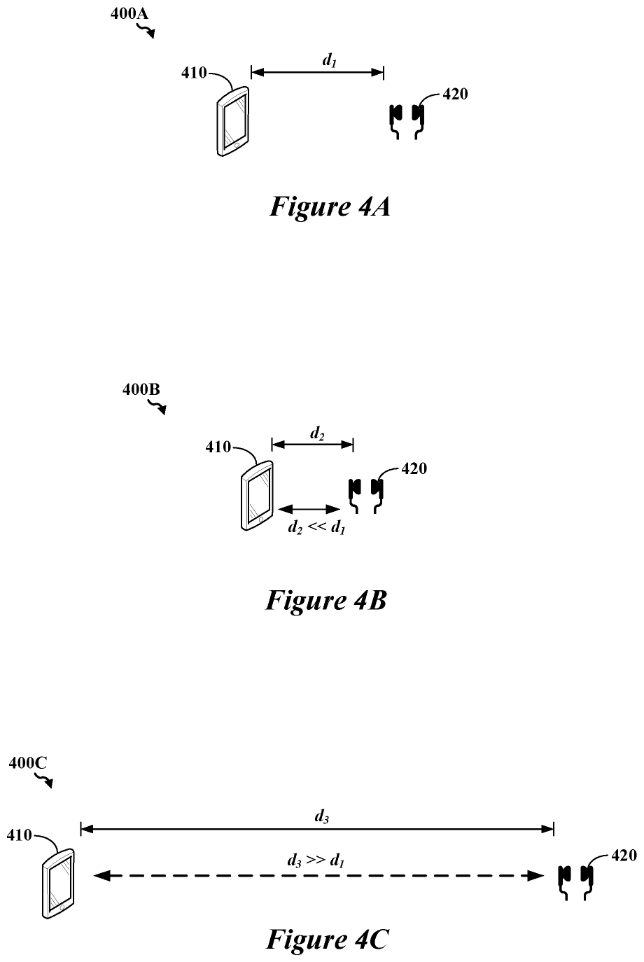

FIGS. 4A-4C depict a wireless device 410 and a peripheral device 420 separated by a configured distance, a relatively short distance, and a relatively long distance, respectively. The wireless device 410 may be one example of the central device 102 of FIG. 1, and the peripheral device 420 may be one example of the peripheral device 112 of FIG. 1. In various aspects, the wireless device 410 and the peripheral device 420 are paired with each other by a Bluetooth connection.

For example, FIG. 4A shows a depiction 400A of the wireless device 410 and the peripheral device 420 being separated by a configured distance d₁, for example, based on a fixed or configured transmit power level used by the wireless device 410 for transmitting Bluetooth audio packets over a Bluetooth connection to the peripheral device 420. Specifically, the configured distance d₁ may correspond to a distance at which the fixed or configured transmit power level is sufficient to deliver the Bluetooth audio packets to the peripheral device 420 with an acceptable level of packet loss and with a certain minimum audio quality while also minimizing power consumption. In some aspects, the fixed or configured transmit power level may be based on a selected maximum packet loss, a selected minimum audio quality, and/or a selected minimum signal strength at the peripheral device 420 when separated from the wireless device 410 by the configured distance d₁.

FIG. 4B shows a depiction 400B of the wireless device 410 and the peripheral device 420 being separated by a relatively short second distance d₂, as compared with the configured distance d₁ of FIG. 4A (e.g., such that d₂<<d₁). Because the distance d₂ is shorter than the configured distance d₁, the Bluetooth audio packets may be transmitted to the peripheral device 420 of FIG. 4B using a lower transmit power level than the fixed or configured transmit power level without reducing audio quality or increasing packet loss. As such, using the fixed or configured transmit power level to transmit Bluetooth audio packets over the relatively short distance d₂ may result in unnecessary power consumption.

FIG. 4C shows a depiction 400C of the wireless device 410 and the peripheral device 420 being separated by a relatively long distance d₃, as compared with the configured distance d₁ (e.g., d₃>>d₁). Because the distance d₃ is longer than the configured distance d₁, a higher transmit power level may be needed to ensure proper delivery of the Bluetooth audio packets to the peripheral device 420. That is, using the fixed or configured transmit power level to transmit Bluetooth audio packets to the peripheral device 420 when the wireless device 410 and the peripheral device 420 are separated by the relatively long distance d₃ may result in greater packet loss and a corresponding reduction in audio quality.

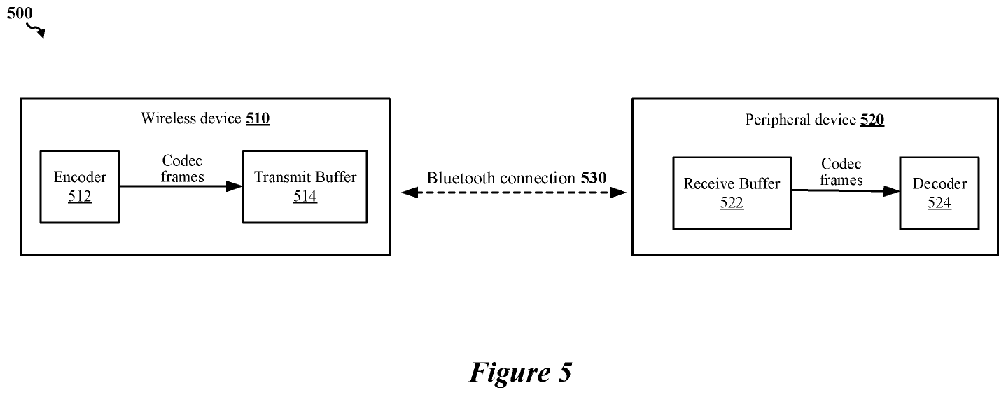

FIG. 5 depicts an example transmission 500 of data packets from a wireless device 510 to a peripheral device 520 over a Bluetooth connection 530, according to various aspects of the present disclosure. In some implementations, the wireless device 510 may be one example of the central device 102 of FIG. 1, the wireless device 200 of FIG. 2, or the wireless device 410 of FIGS. 4A-4C, and the peripheral device 520 may be an example of one or more of the peripheral devices 104, 106, 108, 110, 112 or 114 of FIG. 1 or the peripheral device 420 of FIGS. 4A-4C. In some instances, the peripheral device 720 may be a pair of earbuds such as the earbuds 420 of FIGS. 4A-4B. In some instances, the Bluetooth connection 530 may be one or more of an asynchronous connection-less (ACL) link, a Logical Link Control and Adaptation Protocol (L2CAP) link, an Advanced Audio Distribution Profile (A2DP) link, a synchronous connection-oriented (SCO) link, or an isochronous (ISO) link.

The wireless device 510 is shown to include an encoder 512 and a transmit buffer 514. The encoder 512 may be configured to encode data, such as audio or video data, using a specified bitrate. The transmit buffer 514 may be configured to queue data packets that are to be transmitted over the Bluetooth connection 530 to the peripheral device 520. In some implementations, the data packets to be transmitted over the Bluetooth connection 530 may be of a predefined size, for example, based on the type of link 530 and/or channel conditions associated with the Bluetooth connection 530. In some aspects, data encoded by the encoder 512 may be packetized into a data packet of a predefined size. The wireless device 510 may de-queue data packets from the transmit buffer 514 and transmit the data packets to the peripheral device 520 over the Bluetooth connection 530.

The peripheral device 520 is shown to includer a receive buffer 522 and a decoder 524. Data packets received over the Bluetooth connection 530 may be queued or otherwise stored in the receive buffer 522. The data packets may be output from the receive buffer 522 and forwarded to the decoder 524. In some aspects, the decoder 524 may decode data (such as audio and/or video data) carried in the payloads of the queued data packets, and forward the decoded data to upper layers of the protocol stack for processing and playback to a user. In some implementations, the encoder 512 may encode a first encoder/decoder (codec) frame using a first bitrate, and forward the first codec frame to the transmit buffer 514 to be packetized for transmission to the peripheral device 520 over the Bluetooth connection 530. The peripheral device 520 may queue the received data packet in the receive buffer 522, and may forward the first portion of the first codec frame to the decoder 524 for decoding.

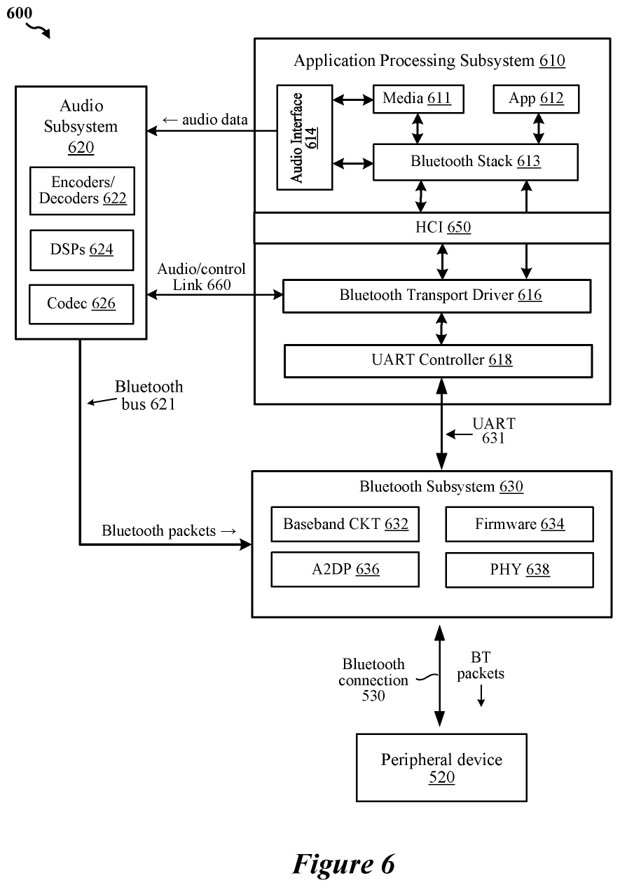

FIG. 6 shows a block diagram of another example wireless device 600, according to various aspects of the present disclosure. In some implementations, the wireless device 600 may be an example of the central device 102 of FIG. 1, the wireless device 200 of FIG. 2, the wireless device 410 of FIGS. 4A-4C, or the wireless device 510 of FIG. 5. In the example of FIG. 6, the wireless device 600 is depicted as having an established Bluetooth connection 530 with the peripheral device 520 of FIG. 5.

The wireless device 600 may include an Application Processing subsystem 610, an audio subsystem 620, a WLAN subsystem 630, a Bluetooth subsystem 630, and a Host Controller Interface (HCl) 650. The Application Processing subsystem 610, which may correspond to at least some portions of the application layer 310 and the Host layer 320 of the BT protocol stack 300 of FIG. 3, is shown to include a media player 611, an Application Layer (App) 612, a Bluetooth stack 613, and an audio interface 614. The media player 611 can be suitable device or component capable of generating or receiving multimedia content including, for example, real-time audio streams, real-time video streams, real-time gaming streams, and other latency-sensitive traffic. The App 612, which may be one implementation of the Application layer 310 FIG. 3, includes at least one Bluetooth profile that defines the collection of attributes and associated permissions to be used in Bluetooth or BLE communications. In some aspects, the App 612 may include processing resources including (but not limited to) the memory 206, the ROM 208, and the Flash memory 210 of FIG. 2. The Bluetooth stack 613 may be one implementation of the BT protocol stack 300 of FIG. 3.

The Bluetooth transport driver 616 may include a split audio and packetization module (not shown for simplicity) that can packetize data (such as audio and/or video data) into Bluetooth frames that can be transmitted to the peripheral device 520 using either a Bluetooth or BLE protocol.

The Bluetooth transport driver 616 is connected to the audio subsystem 620 via an audio and control link 660. In some instances, the audio and control link 660 may be used to send encoded audio/video data and control signals between the Bluetooth transport driver 616 and audio/video DSPs within the audio subsystem 620.

The audio subsystem 620 may include encoders/decoders 622, one or more digital signal processors (DSPs) 624, and one or more codecs 626. The encoders/decoders 622 may be used to sample audio/video data extracted from one or more packets received from another wireless device. The extracted audio/video data may be processed in the Application Processing block 610 based at least in part on the Bluetooth profile. In some implementations, the encoders/decoders 622 may partition the sampled audio/video data into payloads that can be embedded within one or more Bluetooth packets for transmission to the peripheral device 520 over a Bluetooth or BLE connection. In some instances, the DSPs 624 and/or the codecs 626 may employ one or more encoding or decoding algorithms in conjunction with sampling the audio data.

The Bluetooth subsystem 630 may include a Bluetooth baseband circuit 632, Bluetooth firmware 634, an advanced audio distribution profile (A2DP) circuit 636, and a PHY 638. The Bluetooth baseband circuit 632 and the Bluetooth firmware 634 may be used to generate baseband signals for constructing and deconstructing data frames based on the Bluetooth or BLE protocol. The baseband circuit 632 and the Bluetooth firmware 634 may also be used to generate carrier signals for up-converting baseband signals during data transmissions and for down-converting received data signals to baseband. The A2DP circuit 636 may be used to control or manage an A2DP link between the wireless device 600 and the peripheral device 520. Specifically, when the Bluetooth subsystem 630 is in a receive mode, the PHY 638 can be used to receive, demodulate, and down-convert data packets received over the Bluetooth connection 530, and to forward the data packets to the Application Processing subsystem 610. When the Bluetooth subsystem 630 is in a transmit mode, the PHY 638 can be used to encapsulate data provided from the upper layers into one or more Bluetooth frames or packets for transmission to the peripheral device 520 over the Bluetooth connection 530.

In various implementations, the wireless device 600 may be configured to selectively adjust the transmit power level used for transmitting audio packets to the peripheral device 520 over the Bluetooth connection 530. In some aspects, the wireless device 600 may transmit a plurality of audio packets to the peripheral device 520 using an initial transmit power level. The peripheral device 520 may receive at least some of the audio packets, and may determine which of the transmitted audio packets are missing (e.g., transmitted audio packets that were not received or not successfully decoded by the peripheral device). The peripheral device 520 may transmit, to the wireless device 600, one or more NACKs that identify the missing audio packets. The wireless device 600 may obtain, from the received NACKs, a percentage of the transmitted audio packets that were not received or successfully decoded by the peripheral device 520. The wireless device 600 may also obtain indications of the signal strengths of the audio packets transmitted to the peripheral device 520. In response thereto, the wireless device 600 may selectively adjust the transmit power level used for transmitting the audio packets to the peripheral device 520 based on the percentage and the signal strengths. The wireless device 600 may subsequently transmit additional audio packets to the peripheral device 520 using the adjusted transmit power level, rather than the initial transmit power level. In this way, aspects of the present disclosure may ensure that audio packets are transmitted from the wireless device 600 to the peripheral device 520 with sufficient energy to minimize packet loss and ensure a certain audio quality while also minimizing power consumption.

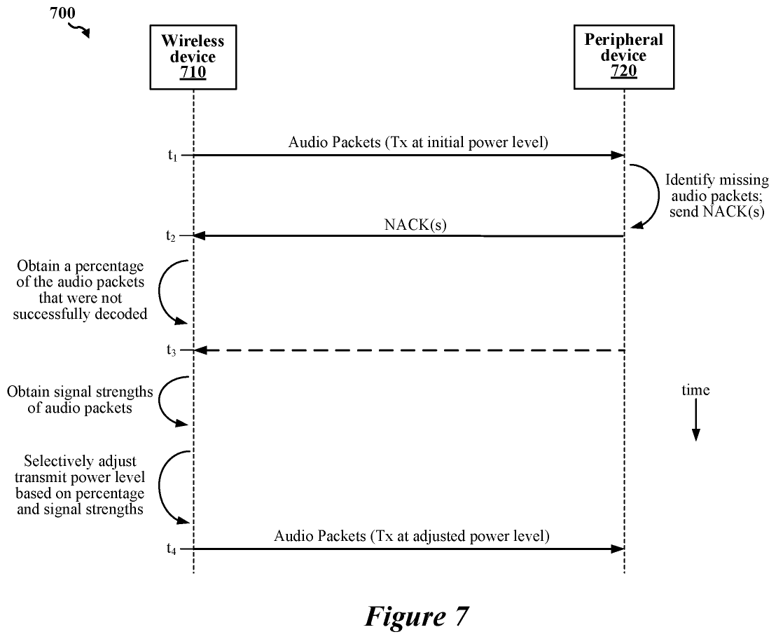

FIG. 7 shows a sequence diagram depicting an example wireless communication 700 that supports a wireless device selectively adjusting the transmit power level used for transmitting audio packets to a peripheral device, according to various aspects of the present disclosure. As shown, the example wireless communication 700 may be performed between a wireless device 710 and a peripheral device 720. The wireless device 710 may be an example of the central device 102 of FIG. 1, the wireless device 200 of FIG. 2, the wireless device 410 of FIGS. 4A-4C, the wireless device 510 of FIG. 5, or the wireless device 600 of FIG. 6. The peripheral device 720, which may be paired with the wireless device 710, may be an example of one or more of the peripheral devices 104, 106, 108, 110, 112, or 114 described with reference to FIG. 1, the peripheral device 420 of FIGS. 4A-4C, or the peripheral device 520 described with reference to FIGS. 5 and 6.

At time t₁, the wireless device 710 transmits, using an initial transmit power level, a plurality of audio packets over a Bluetooth connection to the peripheral device 720. In some instances, the Bluetooth connection may be established using a Bluetooth communication protocol. In some other instances, the Bluetooth connection may be established using a Bluetooth Low Energy communication protocol. The audio packets may carry audio data or audio samples associated with an audio stream, a video stream, a gaming stream, latency-sensitive traffic, or any other suitable traffic. In other implementations, the wireless device 710 may transmit Bluetooth frames carrying other types of data or information.

The peripheral device 720 receives the audio packets, decodes the audio data contained therein, and applies one or more Bluetooth profiles to the decoded audio data. In some implementations, the peripheral device 720 determines whether all of the audio packets transmitted by the wireless device 710 were successfully received, and if not, determines the percentage of the transmitted audio packets that were not received or not successfully decoded by the peripheral device 720. In some instances, the peripheral device 720 may determine a ratio between the number of negative-acknowledgements (NACKs) needed to request retransmission of lost or missing audio packets and the total number of audio packets transmitted by the wireless device 710.

At time t₂, the peripheral device 720 transmits the NACKs to the wireless device 710 over the Bluetooth connection. In some implementations, the peripheral device 720 may also provide an indication of the percentage or ratio of transmitted audio packets that were not received or not successfully decoded by the peripheral device 720. In some instances, the peripheral device 720 may include an indication of the percentage or ratio within one or more of the NACKs. In other instances, the peripheral device 720 may provide the indication of the percentage or ratio to the wireless device 710 in a separate transmission. In other implementations, the peripheral device 720 may not provide an indication, and the wireless device 710 may obtain the percentage or ratio based on the number of audio packets identified for retransmission by the NACKs.

In some implementations, the peripheral device 720 may determine or obtain the signal strengths of at least some of the audio packets transmitted by the wireless device 710. In some aspects, the peripheral device 720 may determine RSSI values of the received audio packets, and may transmit indications of the RSSI values to the wireless device 710 at time t₃. In other instances, the peripheral device 720 may not transmit RSSI values to the wireless device 710, and the wireless device 710 may either obtain the RSSI values from another source or estimate the RSSI values associated with the received audio packets.

The wireless device 710 may use the percentage (or ratio) of the transmitted audio packets that were not received or not successfully decoded by the peripheral device 720, along with the signal strengths of the received audio packets, to selectively adjust the transmit power level used for transmitting audio packets to the peripheral device 720. For example, in some implementations, the wireless device 710 may increase the transmit power level based on the percentage being greater than a first value, or may decrease the transmit power level based on the percentage being less than a second value and the signal strengths being greater than a first level, the second value being less than the first value. In some instances, the wireless device 710 may maintain the transmit power level at a current value based on the percentage being greater than the second value and less than the first value. In other instances, the wireless device 710 may maintain the transmit power level at a current value based on the signal strengths being less than the first value and greater than a second value, the second value being less than the first value.

In addition, or in the alternative, the wireless device 710 may increase the transmit power level based on the signal strengths being less than a packet detect threshold, or may decrease the transmit power level based on the signal strengths being greater than a limit imposed by or associated with a regulatory body or government agency. In some aspects, any decrease in the transmit power level may also be based on the percentage being less than the second value. In some other implementations, the wireless device 710 may increase the transmit power level based on the wireless device and the peripheral device being separated from each other by more than a first distance, or may decrease the transmit power level based on the wireless device and the peripheral device being separated from each other by less than a second distance that is less than the first distance.

At time t₄, the wireless device 710 transmits additional audio packets to the peripheral device 720 using the adjusted transmit power level (rather than the initial transmit power level). In this way, aspects of the present disclosure may ensure that audio packets are transmitted from the wireless device 710 to the peripheral device 720 with sufficient energy to minimize packet loss and ensure a certain audio quality while also minimizing power consumption.

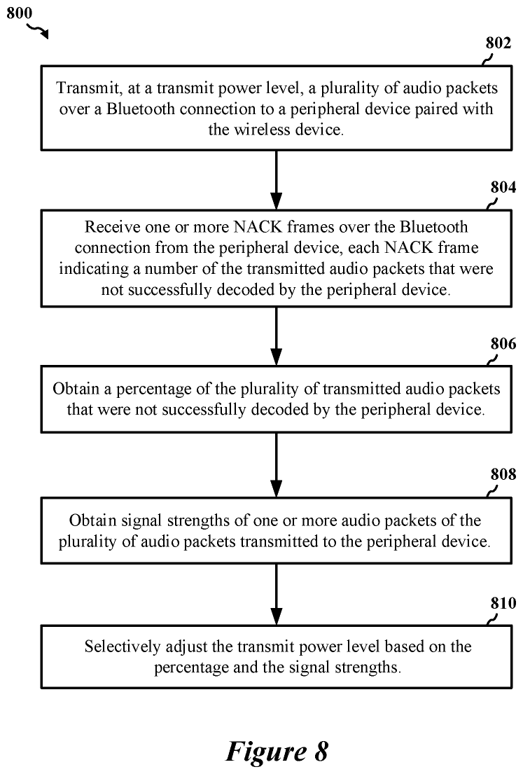

FIG. 8 shows a flowchart illustrating an example operation 800 for wireless communication that supports a wireless device selectively adjusting the transmit power level used for transmitting audio packets to a peripheral device, according to various aspects of the present disclosure. The operation 800 may be performed by a wireless device such as the central device 102 of FIG. 1, the wireless device 200 of FIG. 2, or the wireless device 700 of FIG. 7. In some implementations, the operation 800 may be performed by a wireless device that is connected to or paired with a peripheral device over a Bluetooth connection. In some instances, the wireless device may operate as a STA associated with a WLAN while also operating as a softAP with which the peripheral device is associated. In various aspects, the wireless device may be a smartphone, and the peripheral device may be or may include headphones, headsets, or pairs of earbuds. In some instances, the audio data may be real-time streaming audio. In other instances, the audio data may be an audio stream associated with a real-time gaming application. In some other instances, the audio data may be latency-sensitive traffic.

For example, at 802, the wireless device transmits, at a transmit power level, a plurality of audio packets over a Bluetooth connection to a peripheral device paired with the wireless device. At 804, the wireless device receives one or more NACK frames over the Bluetooth connection from the peripheral device, each NACK frame indicating a number of the transmitted audio packets that were not successfully decoded by the peripheral device. At 806, the wireless device obtains a percentage of the plurality of transmitted audio packets that were not successfully decoded by the peripheral device. At 808, the wireless device obtains signal strengths of one or more audio packets of the plurality of audio packets transmitted to the peripheral device. At 810, the wireless device selectively adjusts the transmit power level based on the percentage and the signal strengths.

In some implementations, the Bluetooth connection may be at least one of an asynchronous connection-less (ACL) link, a Logical Link Control and Adaptation Protocol (L2CAP) link, an Advanced Audio Distribution Profile (A2DP) link, a synchronous connection-oriented (SCO) link, or an isochronous (ISO) link. In various aspects, the percentage may be indicative of a packet loss rate, a packet error rate (PER), or a level of interference on the Bluetooth connection. In some instances, the signal strength may be one or more of a received signal strength indicator (RSSI), a signal-to-noise ratio (SNR), a signal-to-interference plus noise ratio (SINR), or an energy level of a respective audio packet of the plurality of audio packets.

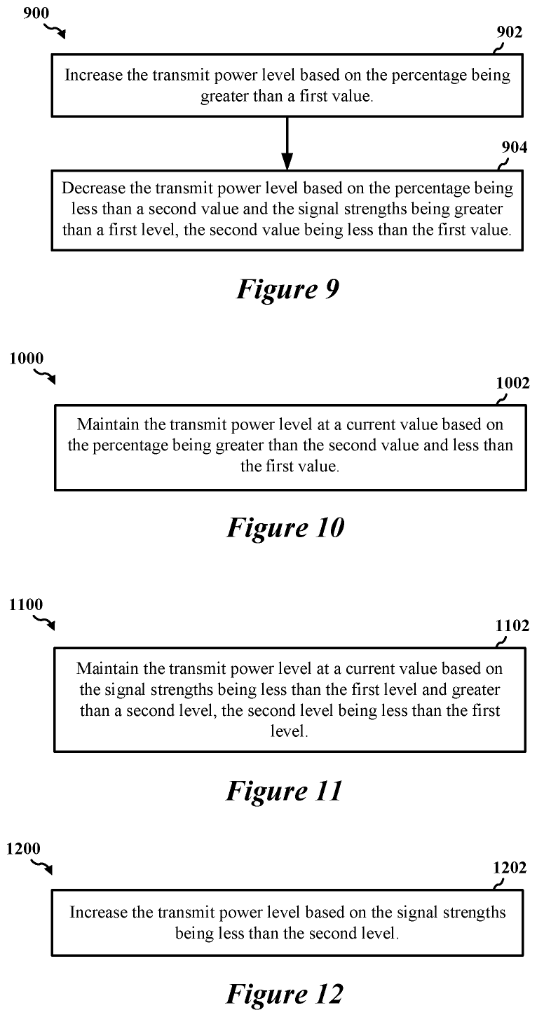

FIG. 9 shows a flowchart illustrating another example operation 900 for wireless communication that supports a wireless device selectively adjusting the transmit power level used for transmitting audio packets to a peripheral device, according to various aspects of the present disclosure. In some instances, the operation 900 may be one example of selectively adjusting the transmit power level at 810 of FIG. 8. For example, at 902, the wireless device increases the transmit power level based on the percentage being greater than a first value. At 904, the wireless device decreases the transmit power level based on the percentage being less than a second value and the signal strengths being greater than a first level, the second value being less than the first value.

FIG. 10 shows a flowchart illustrating another example operation 1000 for wireless communication that supports a wireless device selectively adjusting the transmit power level used for transmitting audio packets to a peripheral device, according to various aspects of the present disclosure. In some instances, the operation 1000 may be another example of selectively adjusting the transmit power level at 810 of FIG. 8. For example, at 1002, the wireless device maintains the transmit power level at a current value based on the percentage being greater than the second value and less than the first value.

FIG. 11 shows a flowchart illustrating another example operation 1100 for wireless communication that supports a wireless device selectively adjusting the transmit power level used for transmitting audio packets to a peripheral device, according to various aspects of the present disclosure. In some instances, the operation 1100 may be another example of selectively adjusting the transmit power level at 810 of FIG. 8. For example, at 1102, the wireless device maintains the transmit power level at a current value based on the signal strengths being less than the first level and greater than a second level, the second level being less than the first level.

FIG. 12 shows a flowchart illustrating another example operation 1200 for wireless communication that supports a wireless device selectively adjusting the transmit power level used for transmitting audio packets to a peripheral device, according to various aspects of the present disclosure. In some instances, the operation 1200 may be performed after the example operation 1100 of FIG. 11. For example, at 1202, the wireless device increases the transmit power level based on the signal strengths being less than the second level.

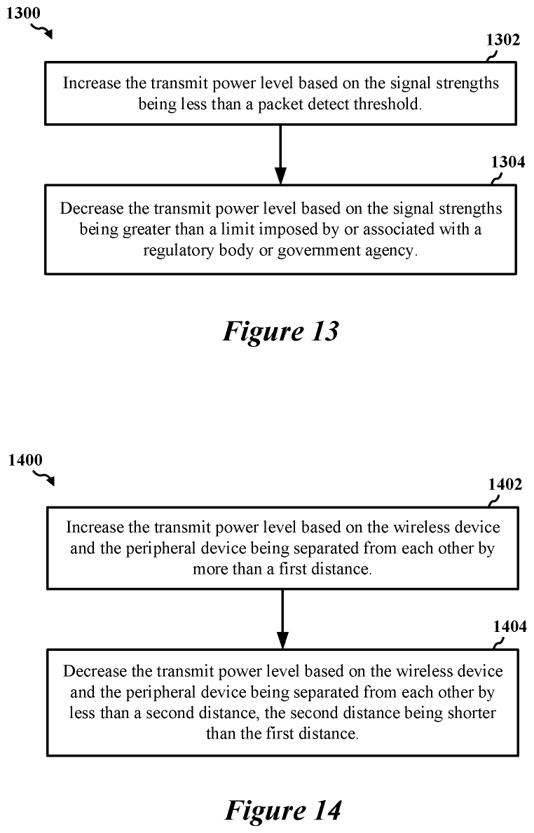

FIG. 13 shows a flowchart illustrating another example operation 1300 for wireless communication that supports a wireless device selectively adjusting the transmit power level used for transmitting audio packets to a peripheral device, according to various aspects of the present disclosure. In some instances, the operation 1300 may be another example of selectively adjusting the transmit power level at 810 of FIG. 8. For example, at 1302, the wireless device increases the transmit power level based on the signal strengths being less than a packet detect threshold. At 1304, the wireless device decreases the transmit power level based on the signal strengths being greater than a limit imposed by or associated with a regulatory body or government agency. In some implementations, decreasing the transmit power level may be further based on the percentage being less than the second value.

FIG. 14 shows a flowchart illustrating another example operation 1400 for wireless communication that supports a wireless device selectively adjusting the transmit power level used for transmitting audio packets to a peripheral device, according to various aspects of the present disclosure. In some instances, the operation 1400 may be another example of selectively adjusting the transmit power level at 810 of FIG. 8. For example, at 1402, the wireless device increases the transmit power level based on the wireless device and the peripheral device being separated from each other by more than a first distance. At 1404, the wireless device decreases the transmit power level based on the wireless device and the peripheral device being separated from each other by less than a second distance, the second distance being shorter than the first distance.

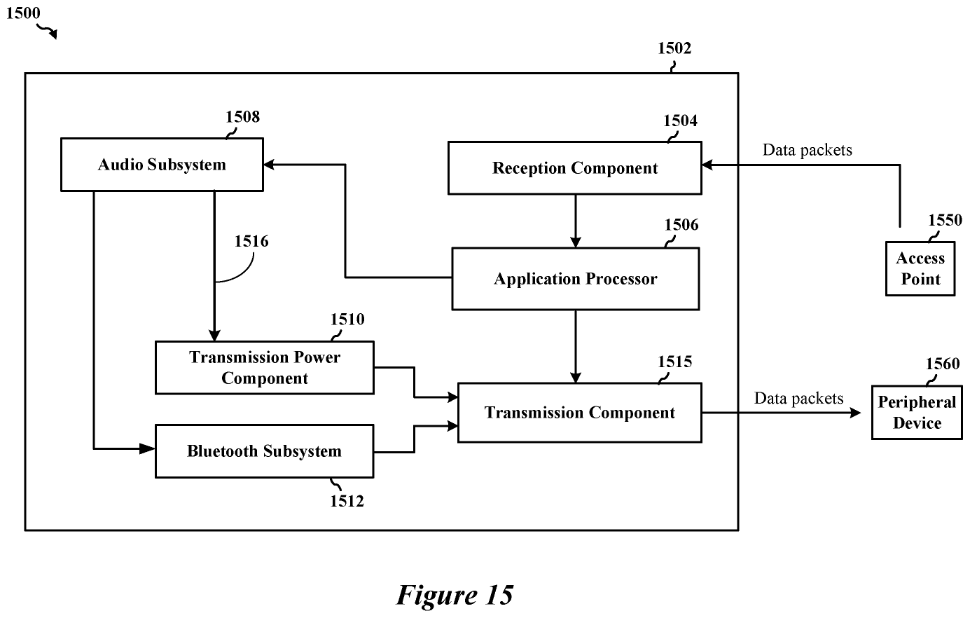

FIG. 15 is a conceptual data flow diagram 1500 illustrating the data flow between different means and/or components of an example apparatus 1502. In some implementations, the apparatus may be a wireless device that is paired with a peripheral device over a Bluetooth connection or link. The apparatus includes a reception component 1504 that receives data packets from other wireless communication devices. The apparatus also includes an application processor 1506, an audio subsystem 1508, a transmission power component 1510, a Bluetooth subsystem 1512, and a transmission component 1514.

The application processor 1506 extracts audio data from received data packets, attaches or applies a Bluetooth profile to the extracted audio data, and routes the extracted audio data to the audio subsystem 1508. The audio subsystem 1508 encodes the audio data, and routes the encoded audio data to the Bluetooth subsystem 1512. The Bluetooth subsystem 1512 embeds the encoded audio data into Bluetooth frames, encapsulates the Bluetooth frames within one or more Bluetooth packets, and forwards the Bluetooth packets to the transmission component 1514 for transmission to the peripheral device over the Bluetooth connection. The transmission component 1514 is coupled to the Bluetooth subsystem 1512, and may be used to transmit frames or packets provided by the Bluetooth subsystem 1512. The transmission power component 1510 may be used to selectively adjust the transmit power level used for transmitting audio packets to a peripheral device (such as headphones, earbuds, or a remote speaker or television) based on a packet loss ratio of the transmitted audio packets and the signal strengths of the audio packets arriving at the peripheral device.

The apparatus may include additional components that perform each of the blocks of the algorithm in the flowcharts of FIGS. 8-14. As such, each block in the flowcharts of FIGS. 8-14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

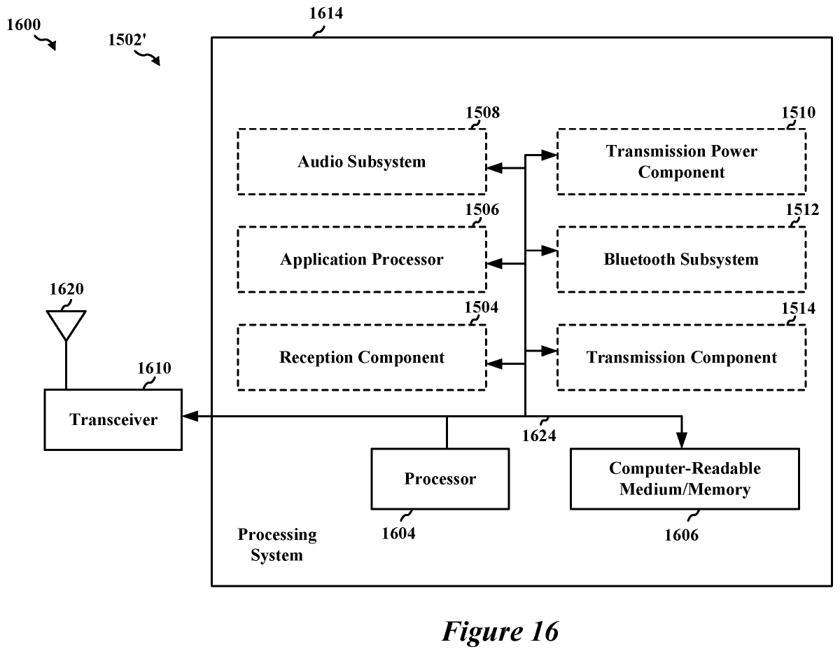

FIG. 16 is a diagram 1600 illustrating an example of a hardware implementation for an apparatus 1502′ employing a processing system 1614. The processing system 1614 may be implemented with a bus architecture, represented generally by the bus 1624. The bus 1624 may include any number of interconnecting buses and bridges depending on the specific application of the processing system 1614 and the overall design constraints. The bus 1624 links together various circuits including one or more processors and/or hardware components, represented by the processor 1604, the components 1504, 1506, 1508, 1510, 1512, and 1514 and the computer-readable medium/memory 1606. The bus 1624 may also link various other circuits such as timing sources, peripherals, voltage regulators, and power management circuits, which are well known in the art, and therefore, will not be described any further.

The processing system 1614 may be coupled to a transceiver 1610. The transceiver 1610 is coupled to one or more antennas 1620. The transceiver 1610 provides a means for communicating with various other apparatus over a transmission medium. The transceiver 1610 receives a signal from the one or more antennas 1620, extracts information from the received signal, and provides the extracted information to the processing system 1614, specifically the reception component 1504. In addition, the transceiver 1610 receives information from the processing system 1614, specifically the transmission component 1514, and based on the received information, generates a signal to be applied to the one or more antennas 1620. The processing system 1614 includes a processor 1604 coupled to a computer-readable medium/memory 1606. The processor 1604 is responsible for general processing, including the execution of software stored on the computer-readable medium/memory 1606. The software, when executed by the processor 1604, causes the processing system 1614 to perform the various functions described supra for any particular apparatus. The computer-readable medium/memory 1606 may also be used for storing data that is manipulated by the processor 1604 when executing software. The processing system 1614 further includes at least one of the components 1504, 1506, 1508, 1510, 1512, and 1514. The components may be software components running in the processor 1604, resident/stored in the computer readable medium/memory 1606, one or more hardware components coupled to the processor 1604, or some combination thereof.

In certain configurations, the apparatus 1502/1502′ for wireless communication may include means for all means limitations described herein. The aforementioned means may be the processor(s) 202, the radio 230, the MMU 240, the WLAN controller 250, the Bluetooth controller 252, the WWAN controller 256, one or more of the aforementioned components of the apparatus 1502 and/or the processing system 1614 of the apparatus 1502′ configured to perform the functions recited by the aforementioned means.

In one configuration, the apparatus 1502/1502′ for wireless communication includes transmitting, at a transmit power level, a plurality of audio packets over a Bluetooth connection to a peripheral device paired with the wireless device; means for receiving one or more NACK frames over the Bluetooth connection from the peripheral device, each NACK frame indicating a number of the transmitted audio packets that were not successfully decoded by the peripheral device; means for obtaining a percentage of the plurality of transmitted audio packets that were not successfully decoded by the peripheral device; means for obtaining signal strengths of one or more audio packets of the plurality of audio packets transmitted to the peripheral device; and means for selectively adjusting the transmit power level based on the percentage and the signal strengths. The aforementioned means may be one or more of the aforementioned components of the apparatus 1602 and/or the processing system 1614 of the apparatus 1502′ configured to perform the functions recited by the aforementioned means. As described supra, the processing system 1614 may include the processors 202, the memory 206, the flash memory 210, and/or the ROM 208 of FIG. 2.

Implementation examples are described in the following numbered clauses:

1. A method of wireless communication by a wireless device, the method including:
transmitting, at a transmit power level, a plurality of audio packets over a Bluetooth connection to a peripheral device paired with the wireless device;
receiving one or more NACK frames over the Bluetooth connection from the peripheral device, each NACK frame indicating a number of the transmitted audio packets that were not successfully decoded by the peripheral device;
obtaining a percentage of the plurality of transmitted audio packets that were not successfully decoded by the peripheral device;
obtaining signal strengths of one or more audio packets of the plurality of audio packets transmitted to the peripheral device; and
selectively adjusting the transmit power level based on the percentage and the signal strengths.

2. The method of clause 1, where the Bluetooth connection includes at least one of an asynchronous connection-less (ACL) link, a Logical Link Control and Adaptation Protocol (L2CAP) link, an Advanced Audio Distribution Profile (A2DP) link, a synchronous connection-oriented (SCO) link, or an isochronous (ISO) link.

3. The method of any one or more of clauses 1-2, where the percentage is indicative of a packet loss rate, a packet error rate (PER), or a level of interference on the Bluetooth connection.

4. The method of any one or more of clauses 1-3, where the signal strength include one or more of a received signal strength indicator (RSSI), a signal-to-noise ratio (SNR), a signal-to-interference plus noise ratio (SINR), or an energy level of a respective audio packet of the plurality of audio packets.

5. The method of any one or more of clauses 1-4, where selectively adjusting the transmit power level includes:
increasing the transmit power level based on the percentage being greater than a first value; or
decreasing the transmit power level based on the percentage being less than a second value and the signal strengths being greater than a first level, the second value being less than the first value.

6. The method of clause 5, where selectively adjusting the transmit power level further includes:
maintaining the transmit power level at a current value based on the percentage being greater than the second value and less than the first value.

7. The method of clause 5, where selectively adjusting the transmit power level further includes:
maintaining the transmit power level at a current value based on the signal strengths being less than the first level and greater than a second level, the second level being less than the first level.

8. The method of clause 7, where selectively adjusting the transmit power level further includes:
increasing the transmit power level based on the signal strengths being less than the second level.

9. The method of any one or more of clauses 1-8, where selectively adjusting the transmit power level further includes:
increasing the transmit power level based on the signal strengths being less than a packet detect threshold; or
decreasing the transmit power level based on the signal strengths being greater than a limit imposed by or associated with a regulatory body or government agency.

10. The method of clause 9, where decreasing the transmit power level is further based on the percentage being less than a value.

11. The of any one or more of clauses 1-10, where selectively adjusting the transmit power level further includes:
increasing the transmit power level based on the wireless device and the peripheral device being separated from each other by more than a first distance; or
decreasing the transmit power level based on the wireless device and the peripheral device being separated from each other by less than a second distance, the second distance being shorter than the first distance.

12. The method of any one or more of clauses 1-11, where the signal strengths indicate received signal strength indicator (RSSI) values of at least some of the plurality of audio packets received at the peripheral device.

13. The method of any one or more of clauses 1-12, where the signal strengths indicate received signal strength indicator (RSSI) values of at least some of the NACK frames received from the peripheral device.

14. A wireless device, including:
one or more processors; and
a memory coupled to the one or more processors and storing processor-readable code that, when executed by the one or more processors, is configured to:
   transmit, at a transmit power level, a plurality of audio packets over a Bluetooth connection to a peripheral device paired with the wireless device;
   receive one or more NACK frames over the Bluetooth connection from the peripheral device, each NACK frame indicating a number of the transmitted audio packets that were not successfully decoded by the peripheral device;
   obtain a percentage of the plurality of transmitted audio packets that were not successfully decoded by the peripheral device;
   obtain signal strengths of one or more audio packets of the plurality of audio packets transmitted to the peripheral device; and
   selectively adjust the transmit power level based on the percentage and the signal strengths.

15. The wireless device of clause 14, where the Bluetooth connection includes at least one of an asynchronous connection-less (ACL) link, a Logical Link Control and Adaptation Protocol (L2CAP) link, an Advanced Audio Distribution Profile (A2DP) link, a synchronous connection-oriented (SCO) link, or an isochronous (ISO) link.

16. The wireless device of any one or more of clauses 14-15, where the percentage is indicative of a packet loss rate, a packet error rate (PER), or a level of interference on the Bluetooth connection.

17. The wireless device of any one or more of clauses 14-16, where the signal strength include one or more of a received signal strength indicator (RSSI), a signal-to-noise ratio (SNR), a signal-to-interference plus noise ratio (SINR), or an energy level of a respective audio packet of the plurality of audio packets.

18. The wireless device of clause 14, where execution of the processor-readable code to selectively adjust the transmit power level is further configured to:
increase the transmit power level based on the percentage being greater than a first value; or
decrease the transmit power level based on the percentage being less than a second value and the signal strengths being greater than a first level, the second value being less than the first value.

19. The wireless device of clause 18, where execution of the processor-readable code to selectively adjust the transmit power level is further configured to:
maintain the transmit power level at a current value based on the percentage being greater than the second value and less than the first value.

20. The wireless device of clause 18, where execution of the processor-readable code to selectively adjust the transmit power level is further configured to:
maintain the transmit power level at a current value based on the signal strengths being less than the first level and greater than a second level, the second level being less than the first level.

21. The wireless device of clause 20, where execution of the processor-readable code to selectively adjust the transmit power level is further configured to:
increase the transmit power level based on the signal strengths being less than the second level.

22. The wireless device of any one or more of clauses 14-21, where execution of the processor-readable code to selectively adjust the transmit power level is further configured to:
increase the transmit power level based on the signal strengths being less than a packet detect threshold; or
decrease the transmit power level based on the signal strengths being greater than a limit imposed by or associated with a regulatory body or government agency.

23. The wireless device of clause 22, where decreasing the transmit power level is further based on the percentage being less than a value.

24. The wireless device of any one or more of clauses 14-23, where execution of the processor-readable code to selectively adjust the transmit power level is further configured to:
increase the transmit power level based on the wireless device and the peripheral device being separated from each other by more than a first distance; or
decrease the transmit power level based on the wireless device and the peripheral device being separated from each other by less than a second distance, the second distance being shorter than the first distance.

25. The wireless device of any one or more of clauses 14-24, where the signal strengths indicate received signal strength indicator (RSSI) values of at least some of the plurality of audio packets received at the respective peripheral devices.

26. The wireless device of any one or more of clauses 14-25, where the signal strengths indicate received signal strength indicator (RSSI) values of at least some of the NACK frames received from the peripheral device.

27. A wireless device, including:
means for transmitting, at a transmit power level, a plurality of audio packets over a Bluetooth connection to a peripheral device paired with the wireless device;
means for receiving one or more NACK frames over the Bluetooth connection from the peripheral device, each NACK frame indicating a number of the transmitted audio packets that were not successfully decoded by the peripheral device;
means for obtaining a percentage of the plurality of transmitted audio packets that were not successfully decoded by the peripheral device;
means for signal strengths of one or more audio packets of the plurality of audio packets transmitted to the peripheral device; and
means for selectively adjusting the transmit power level based on the percentage and the signal strengths.

28. The wireless device of clause 27, where the Bluetooth connection includes at least one of an asynchronous connection-less (ACL) link, a Logical Link Control and Adaptation Protocol (L2CAP) link, an Advanced Audio Distribution Profile (A2DP) link, a synchronous connection-oriented (SCO) link, or an isochronous (ISO) link.

29. The wireless device of any one or more of clauses 27-28, where the percentage is indicative of a packet loss rate, a packet error rate (PER), or a level of interference on the Bluetooth connection.

30. The wireless device of any one or more of clauses 27-29, where the signal strength include one or more of a received signal strength indicator (RSSI), a signal-to-noise ratio (SNR), a signal-to-interference plus noise ratio (SINR), or an energy level of a respective audio packet of the plurality of audio packets.

31. The wireless device of clause 27, where the means for selectively adjusting the transmit power level is configured to:
increase the transmit power level based on the percentage being greater than a first value; or
decrease the transmit power level based on the percentage being less than a second value and the signal strengths being greater than a first level, the second value being less than the first value.

32. The wireless device of clause 31, where the means for selectively adjusting the transmit power level is further configured to:
maintain the transmit power level at a current value based on the percentage being greater than the second value and less than the first value.

33. The wireless device of clause 31, where the means for selectively adjusting the transmit power level is further configured to:
maintain the transmit power level at a current value based on the signal strengths being less than the first level and greater than a second level, the second level being less than the first level.

34. The wireless device of clause 33, where the means for selectively adjusting the transmit power level is further configured to:
increase the transmit power level based on the signal strengths being less than the second level.

35. The wireless device of any one or more of clauses 27-34, where the means for selectively adjusting the transmit power level is configured to:
increase the transmit power level based on the signal strengths being less than a packet detect threshold; or
decrease the transmit power level based on the signal strengths being greater than a limit imposed by or associated with a regulatory body or government agency.

36. The wireless device of any one or more of clauses 27-35, where decreasing the transmit power level is further based on the percentage being less than a value.

37. The wireless device of any one or more of clauses 27-36, where the means for selectively adjusting the transmit power level is configured to:
increase the transmit power level based on the wireless device and the peripheral device being separated from each other by more than a first distance; or
decrease the transmit power level based on the wireless device and the peripheral device being separated from each other by less than a second distance, the second distance being shorter than the first distance.

38. The wireless device of any one or more of clauses 27-37, where the signal strengths indicate received signal strength indicator (RSSI) values of at least some of the plurality of audio packets received at the peripheral device.

39. The wireless device of any one or more of clauses 27-38, where the signal strengths indicate received signal strength indicator (RSSI) values of at least some of the NACK frames received from the peripheral device.

40. A non-transitory computer-readable storage medium storing instructions, that, when executed by one or more processors of a wireless device, cause the wireless device to perform operations including:
transmitting, at a transmit power level, a plurality of audio packets over a Bluetooth connection to a peripheral device paired with the wireless device;
receiving one or more NACK frames over the Bluetooth connection from the peripheral device, each NACK frame indicating a number of the transmitted audio packets that were not successfully decoded by the peripheral device;
obtaining a percentage of the plurality of transmitted audio packets that were not successfully decoded by the peripheral device;
obtaining signal strengths of one or more audio packets of the plurality of audio packets transmitted to the peripheral device; and
selectively adjusting the transmit power level based on the percentage and the signal strengths.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations, and algorithm processes described in connection with the implementations disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described herein. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described herein as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described herein should not be understood as requiring such separation in all implementations, and it should be understood that the described program components and systems can generally be integrated together in a single software product or packaged into multiple software products.

What is claimed is:

1. A method of wireless communication by a wireless device, the method comprising:
transmitting, at a transmit power level, a plurality of audio packets over a Bluetooth connection to a peripheral device paired with the wireless device;
receiving one or more NACK frames over the Bluetooth connection from the peripheral device, each NACK frame indicating a number of the transmitted audio packets that were not successfully decoded by the peripheral device;
obtaining a percentage of the plurality of transmitted audio packets that were not successfully decoded by the peripheral device;
obtaining signal strengths of one or more audio packets of the plurality of audio packets transmitted to the peripheral device; and
selectively adjusting the transmit power level based on the percentage and the signal strengths.

2. The method of claim 1, wherein the Bluetooth connection comprises at least one of an asynchronous connection-less (ACL) link, a Logical Link Control and Adaptation Protocol (L2CAP) link, an Advanced Audio Distribution Profile (A2DP) link, a synchronous connection-oriented (SCO) link, or an isochronous (ISO) link.

3. The method of claim 1, wherein the percentage is indicative of a packet loss rate, a packet error rate (PER), or a level of interference on the Bluetooth connection.

4. The method of claim 1, wherein the signal strength comprise one or more of a received signal strength indicator (RSSI), a signal-to-noise ratio (SNR), a signal-to-interference plus noise ratio (SINR), or an energy level of a respective audio packet of the plurality of audio packets.

5. The method of claim 1, wherein selectively adjusting the transmit power level includes:
increasing the transmit power level based on the percentage being greater than a first value; or
decreasing the transmit power level based on the percentage being less than a second value and the signal strengths being greater than a first level, the second value being less than the first value.

6. The method of claim 5, wherein selectively adjusting the transmit power level further includes:
maintaining the transmit power level at a current value based on the percentage being greater than the second value and less than the first value.

7. The method of claim 5, wherein selectively adjusting the transmit power level further includes:
maintaining the transmit power level at a current value based on the signal strengths being less than the first level and greater than a second level, the second level being less than the first level.

8. The method of claim 7, wherein selectively adjusting the transmit power level further includes:
increasing the transmit power level based on the signal strengths being less than the second level.

9. The method of claim 1, wherein selectively adjusting the transmit power level further includes:
increasing the transmit power level based on the signal strengths being less than a packet detect threshold; or
decreasing the transmit power level based on the signal strengths being greater than a limit imposed by or associated with a regulatory body or government agency.

10. The method of claim 9, wherein decreasing the transmit power level is further based on the percentage being less than a value.

11. The method of claim 1, wherein selectively adjusting the transmit power level further includes:
increasing the transmit power level based on the wireless device and the peripheral device being separated from each other by more than a first distance; or
decreasing the transmit power level based on the wireless device and the peripheral device being separated from each other by less than a second distance, the second distance being shorter than the first distance.

12. The method of claim 1, wherein the signal strengths indicate received signal strength indicator (RSSI) values of at least some of the plurality of audio packets received at the peripheral device.

13. The method of claim 1, wherein the signal strengths indicate received signal strength indicator (RSSI) values of at least some of the NACK frames received from the peripheral device.

14. A wireless device, comprising:
one or more processors; and
a memory coupled to the one or more processors and storing processor-readable code that, when executed by the one or more processors, is configured to:
transmit, at a transmit power level, a plurality of audio packets over a Bluetooth connection to a peripheral device paired with the wireless device;
receive one or more NACK frames over the Bluetooth connection from the peripheral device, each NACK frame indicating a number of the transmitted audio packets that were not successfully decoded by the peripheral device;
obtain a percentage of the plurality of transmitted audio packets that were not successfully decoded by the peripheral device;
obtain signal strengths of one or more audio packets of the plurality of audio packets transmitted to the peripheral device; and
selectively adjust the transmit power level based on the percentage and the signal strengths.

15. The wireless device of claim 14, wherein the Bluetooth connection comprises at least one of an asynchronous connection-less (ACL) link, a Logical Link Control and Adaptation Protocol (L2CAP) link, an Advanced Audio Distribution Profile (A2DP) link, a synchronous connection-oriented (SCO) link, or an isochronous (ISO) link.

16. The wireless device of claim 14, wherein the percentage is indicative of a packet loss rate, a packet error rate (PER), or a level of interference on the Bluetooth connection.

17. The wireless device of claim 14, wherein the signal strength comprise one or more of a received signal strength indicator (RSSI), a signal-to-noise ratio (SNR), a signal-to-interference plus noise ratio (SINR), or an energy level of a respective audio packet of the plurality of audio packets.

18. The wireless device of claim 14, wherein execution of the processor-readable code to selectively adjust the transmit power level is further configured to:
increase the transmit power level based on the percentage being greater than a first value; or
decrease the transmit power level based on the percentage being less than a second value and the signal strengths being greater than a first level, the second value being less than the first value.

19. The wireless device of claim 18, wherein execution of the processor-readable code to selectively adjust the transmit power level is further configured to:
maintain the transmit power level at a current value based on the percentage being greater than the second value and less than the first value.

20. The wireless device of claim 18, wherein execution of the processor-readable code to selectively adjust the transmit power level is further configured to:
maintain the transmit power level at a current value based on the signal strengths being less than the first level and greater than a second level, the second level being less than the first level.

21. The wireless device of claim 20, wherein execution of the processor-readable code to selectively adjust the transmit power level is further configured to:
increase the transmit power level based on the signal strengths being less than the second level.

22. The wireless device of claim 14, wherein execution of the processor-readable code to selectively adjust the transmit power level is further configured to:
increase the transmit power level based on the signal strengths being less than a packet detect threshold; or
decrease the transmit power level based on the signal strengths being greater than a limit imposed by or associated with a regulatory body or government agency.

23. The wireless device of claim 22, wherein decreasing the transmit power level is further based on the percentage being less than a value.

24. The wireless device of claim 14, wherein execution of the processor-readable code to selectively adjust the transmit power level is further configured to:
increase the transmit power level based on the wireless device and the peripheral device being separated from each other by more than a first distance; or
decrease the transmit power level based on the wireless device and the peripheral device being separated from each other by less than a second distance, the second distance being shorter than the first distance.

25. The wireless device of claim 14, wherein the signal strengths indicate received signal strength indicator (RSSI) values of at least some of the plurality of audio packets received at the respective peripheral devices.

26. The wireless device of claim 14, wherein the signal strengths indicate received signal strength indicator (RSSI) values of at least some of the NACK frames received from the peripheral device.

27. A wireless device, comprising:
means for transmitting, at a transmit power level, a plurality of audio packets over a Bluetooth connection to a peripheral device paired with the wireless device;
means for receiving one or more NACK frames over the Bluetooth connection from the peripheral device, each NACK frame indicating a number of the transmitted audio packets that were not successfully decoded by the peripheral device;
means for obtaining a percentage of the plurality of transmitted audio packets that were not successfully decoded by the peripheral device;
means for signal strengths of one or more audio packets of the plurality of audio packets transmitted to the peripheral device; and
means for selectively adjusting the transmit power level based on the percentage and the signal strengths.

28. The wireless device of claim 27, wherein the Bluetooth connection comprises at least one of an asynchronous connection-less (ACL) link, a Logical Link Control and Adaptation Protocol (L2CAP) link, an Advanced Audio Distribution Profile (A2DP) link, a synchronous connection-oriented (SCO) link, or an isochronous (ISO) link.

29. The wireless device of claim 27, wherein the percentage is indicative of a packet loss rate, a packet error rate (PER), or a level of interference on the Bluetooth connection.

30. The wireless device of claim 27, wherein the signal strength comprise one or more of a received signal strength indicator (RSSI), a signal-to-noise ratio (SNR), a signal-to-interference plus noise ratio (SINR), or an energy level of a respective audio packet of the plurality of audio packets.

31. The wireless device of claim 27, wherein the means for selectively adjusting the transmit power level is configured to:
increase the transmit power level based on the percentage being greater than a first value; or
decrease the transmit power level based on the percentage being less than a second value and the signal strengths being greater than a first level, the second value being less than the first value.

32. The wireless device of claim 31, wherein the means for selectively adjusting the transmit power level is further configured to:
maintain the transmit power level at a current value based on the percentage being greater than the second value and less than the first value.

33. The wireless device of claim 31, wherein the means for selectively adjusting the transmit power level is further configured to:
maintain the transmit power level at a current value based on the signal strengths being less than the first level and greater than a second level, the second level being less than the first level.

34. The wireless device of claim 33, wherein the means for selectively adjusting the transmit power level is further configured to:
increase the transmit power level based on the signal strengths being less than the second level.

35. The wireless device of claim 27, wherein the means for selectively adjusting the transmit power level is configured to:
increase the transmit power level based on the signal strengths being less than a packet detect threshold; or
decrease the transmit power level based on the signal strengths being greater than a limit imposed by or associated with a regulatory body or government agency.

36. The wireless device of claim 35, wherein decreasing the transmit power level is further based on the percentage being less than a value.

37. The wireless device of claim 27, wherein the means for selectively adjusting the transmit power level is configured to:
increase the transmit power level based on the wireless device and the peripheral device being separated from each other by more than a first distance; or
decrease the transmit power level based on the wireless device and the peripheral device being separated from each other by less than a second distance, the second distance being shorter than the first distance.

38. The wireless device of claim 27, wherein the signal strengths indicate received signal strength indicator (RSSI) values of at least some of the plurality of audio packets received at the peripheral device.

39. The wireless device of claim 27, wherein the signal strengths indicate received signal strength indicator (RSSI) values of at least some of the NACK frames received from the peripheral device.

40. A non-transitory computer-readable storage medium storing instructions, that, when executed by one or more processors of a wireless device, cause the wireless device to perform operations including:
transmitting, at a transmit power level, a plurality of audio packets over a Bluetooth connection to a peripheral device paired with the wireless device;
receiving one or more NACK frames over the Bluetooth connection from the peripheral device, each NACK frame indicating a number of the transmitted audio packets that were not successfully decoded by the peripheral device;
obtaining a percentage of the plurality of transmitted audio packets that were not successfully decoded by the peripheral device;
obtaining signal strengths of one or more audio packets of the plurality of audio packets transmitted to the peripheral device; and
selectively adjusting the transmit power level based on the percentage and the signal strengths.
